(19) United States
(12) Patent Application Publication
(10) Pub. No.: US 2011/0055492 A1
(43) Pub. Date: Mar. 3, 2011

(54) MULTIPLE PROCESSING CORE DATA SORTING

(76) Inventors: Ren Wu, San Jose, CA (US); Bin Zhang, Fremont, CA (US); Meichun Hsu, Los Altos Hills, CA (US)

(21) Appl. No.: 12/553,883

(22) Filed: Sep. 3, 2009

(51) Int. Cl. G06F 12/10

(52) U.S. Cl. 711/149; 711/E12.066

(57) ABSTRACT

Sorting data using a multi-core processing system is disclosed. An unsorted data set is copied from a global memory device to a shared memory device. The global memory device can store data sets for the multi-core processing system. The shared memory device can store unsorted data sets for sorting. The unsorted data set can include a plurality of data elements. The unsorted data set can be sorted into sorted data in parallel on the shared memory device using a cluster of processors of the multi-core processing system. The cluster of processors may include at least as many processors as a number of the data elements in the unsorted data set. The sorted data can be copied from the shared memory device to the global memory device.

### BACKGROUND

Efficient sorting of data is an issue commonly encountered in the application of computer technologies. Various sorting methods have been developed which have advanced the state of knowledge in this area and increased an efficiency of sorting even very large arrays. Such sorting methods have often had various drawbacks. For example, certain sorter processes may be applicable to certain list sizes but may not be easily modifiable to sort longer or shorter lists. With some sorter processes, unless data is pipelined through a network, many of the sorting resources may be idle at a given time. With some sorting systems, many of the sorting resources may be idle for as much as half the total processing time or more while data is being rearranged.

Central Processing Units (CPUs) have often been used for sorting data lists, arrays, and the like. However, as the ability to store larger data sets increases, the amount of data to be sorted has increased as well, and additional efforts are made to keep up with a sometimes exponentially growing volume of data. One advancement that has allowed CPUs to sort larger volumes of data is the increase in a number of cores in the CPU. However, a current number of cores in a CPU is still relatively small, particularly as compared with a current number of cores found in many Graphical Processing Units (GPUs). Modem GPUs may contain up to several hundred processing cores or more.

Using traditional sorting methods on CPUs or GPUs can result in inefficient use of processing resources and many of the cores may be idle while sorting such a large number of small jobs. Companies have desired a way to effectively sort large numbers of small jobs and to be able to do so in a way that efficiently uses processing resources and increases the speed at which sorting jobs are completed.

### BRIEF DESCRIPTION OF THE DRAWINGS

FIG. 1 is a block diagram of mapping data sets to processing cores in accordance with an embodiment;

FIG. 2 is a block diagram of a multi-core processing system for data sorting in accordance with an embodiment;

FIG. 3 is a flow diagram of a method for sorting data using a multi-core processing system in accordance with an embodiment; and

FIG. 4 is a flow diagram of a method for sorting a plurality of unsorted data sets using a multi-core processing system in accordance with an embodiment.

### DETAILED DESCRIPTION OF EXAMPLE EMBODIMENT(S)

Reference will now be made to the exemplary embodiments illustrated, and specific language will be used herein to describe the same. It will nevertheless be understood that no limitation of the scope of the invention is thereby intended. Additional features and advantages of the invention will be apparent from the detailed description which follows, taken in conjunction with the accompanying drawings, which together illustrate, by way of example, features of the invention.

A GPU system can interface to a main computer memory or to a CPU through a Peripheral Component Interconnect Express (PCIe) bus. This can give the GPU system a throughput to and from the main computer memory. Data can be read from the main computer memory into the GPU system. A GPU global memory, internal memory (or shared memory), and cache (e.g., constant memory, texture memory) may be organized to facilitate processing. In particular, the type of processing performed by the GPU may include sorting, among other tasks.

Many current systems exist which utilize CPUs and GPUs to perform data sorting tasks. GPUs typically may contain specialized hardware that is optimized to render a screen image from a set of input data. The use of a GPU can improve both graphics and a general purpose computing performance of the workstation. General purpose computing performance can be improved because the general purpose processor may not be burdened with the computation-intensive task of rendering the screen image. Because GPUs can provide a boost to performance of computation-intensive tasks, some sorting mechanisms have begun to use GPUs and the many cores in a GPU for sorting large sets of data.

However, these systems are designed to be able to sort very large sets of data and may not be well suited for sorting a large number of small or very small sets of data. Generally, prior systems are designed to sort a number of data elements which far exceeds a number of available processors or processing cores. As the number of processor cores in computing systems increases, the number of processors can exceed the number of elements in a sorting job. For example, in some network flow problems in which sorting is performed, a sorting job may be small and may contain 16 or 32 data elements to be sorted, but there may be hundreds of thousands of sorting jobs to be completed. While current CPUs generally are limited to a relatively small number of cores, current GPUs may include up to several hundred cores or more. Such GPUs therefore may have many times more cores available for processing than data elements to be sorted.

While many modern sorting systems are making improvements with sorting very large data sets, such systems are not able to sort a large amount of small data sets nearly as efficiently whether using a CPU or GPU. Accordingly, there is a need for an ability to sort many small sorting jobs in a manner that fully or nearly fully utilizes all of the resources available and in a fast and efficient manner.

Accordingly, sorting data using a multi-core processing system is described. An unsorted data set is copied from a global memory device to a shared memory device. The global memory device and shared memory device can respectively be a part of a memory chip, or may be on a graphics processor card, or may be remote from processor cores, graphics cards and the like. In one aspect, the global memory device may comprise system Random Access Memory (RAM) for the computing system and a bus may be used to communicate between the processor cores and the system RAM. Other global and shared memory configurations are also contemplated. The global memory device can store data sets for the multi-core processing system. The shared memory device can store the unsorted data sets for sorting. The unsorted data set can include a plurality of data elements. The unsorted data set can be sorted into sorted data in parallel on the shared memory device using a cluster of processors of the multi-core processing system. The cluster of processors may include at least as many processors as the number of the data elements in the unsorted data set. The sorted data can be copied from the shared memory device to the global memory device, such as after all of the unsorted data on the shared memory device has been sorted.

In one aspect, data sets and/or data elements may be “mapped” to a cluster of processing cores for efficient sorting. “Mapped” or “mapping” as used herein can refer to the creation of a correspondence between data and processing cores. Alternatively, “mapped” or “mapping” can refer to organization of data or processors (e.g., cores) before creating a correspondence between them. For example, a set of data elements may be grouped into subsets, or a plurality of processing cores may be grouped into clusters. Grouping may not necessarily refer to any action being taken on the processors or data, but may be merely an identification of data or processing cores.

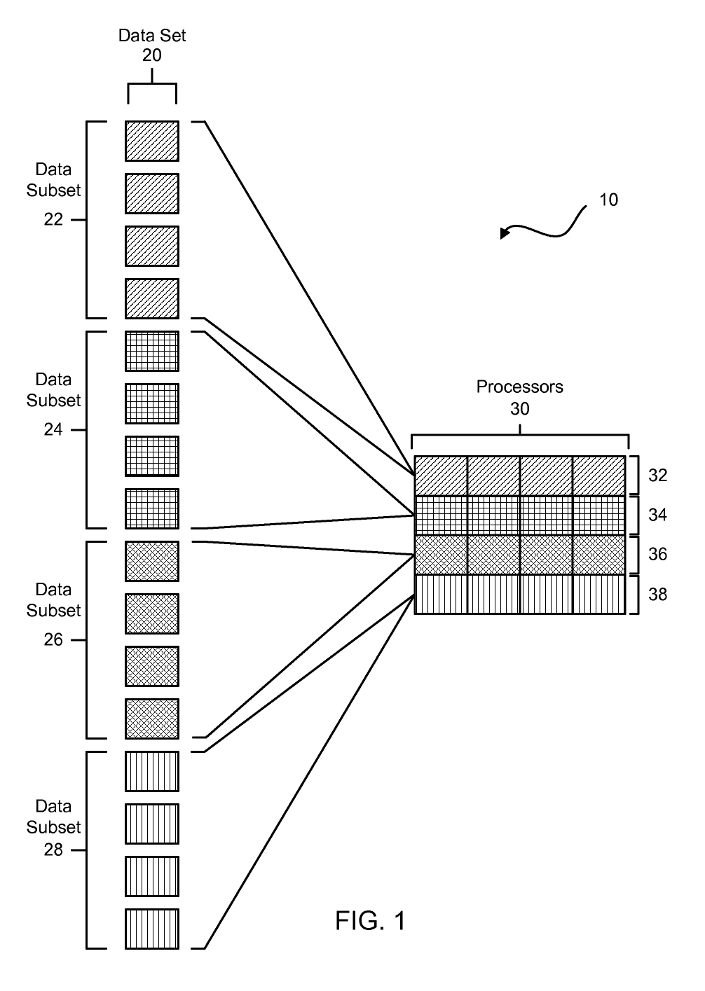

Referring to FIG. 1, a block diagram of data set mapping 10 to processing cores is shown in accordance with an embodiment. A data set 20 is provided having a number of data elements. The data set shown in FIG. 1 includes 16 data elements, but may include any number of data elements. The data set may include subsets of data 22, 24, 26, 28. Each subset may represent a group of data elements which is to be sorted. In FIG. 1, the set of data includes four subsets of data representing data subsets for four different sorting jobs. While in FIG. 1 four data subsets are shown and each data subset includes four data elements, any number of data subsets having any number of data elements may be available for sorting.

A plurality of processors 30 may be provided. The plurality of processors may be part of a multi-core processing system. As used herein, processor cores may be referred to simply as “processors”. The plurality of processors shown in FIG. 1 includes 16 processors, but in practice may include any number of processors. Also, the processors in FIG. 1 are shown as being arranged into a two-dimensional processor block, or a 4×4 grid of processors. The depiction of the processors as a processor block can be useful for demonstrating data mapping and sorting herein, but may not necessarily represent an actual physical layout of processors. Further, the arrangement of processors and the dimensions of the arrangement may vary. While the processors here are shown in a physically arranged processor block for illustrative purposes, in one aspect, the system may actually logically “arrange” available processors into a block or other arrangement for data mapping and/or sorting purposes. This logical arrangement of processors may be a mapping of the plurality of processors into a plurality of clusters 32, 34, 36, 38 of processors and may be one step taken to efficiently maximize use of resources of the multi-core processing system.

In one aspect, the processors 30 may be mapped into processor clusters 32, 34, 36, 38. The processor mapping may simply be recognition of physical clustering of processors on the GPU. For example, a GPU having 16 cores may have four physical clusters of four processors each. In one aspect, data sorting may be performed more efficiently when a cluster of processors uses a same shared memory. In many instances, clusters of processors on a GPU have a local shared memory which is shared among processors in the cluster but may not be shared with processors in a different cluster. Accordingly, processor mapping may be at least partially representative of processors which share memory in some embodiments. For example, each row of processors in the processor block of FIG. 1 represents a cluster of processors with shared memory. Different rows of processors do not necessarily have a common shared memory in this example. As described above, the processor mapping may not necessarily be representative of a physical layout of processors. For example, a GPU may include physical core clusters of 16 cores. If four sorting jobs each having four data elements were presented (as in FIG. 1), a single physical cluster of 16 cores may be mapped onto four clusters of four cores which may all use their own shared memory. Although a same shared memory may be used among the different rows or different clusters, the rows are not necessarily sharing information between the rows. Each row may be responsible for a separate sorting job and sharing data between sorting jobs could result in erroneously sorted data.

To summarize operation of the mapping of FIG. 1, a data set 20 having multiple subsets of data 22, 24, 26, 28 each representing a sorting job is provided, and each subset of data is mapped to a cluster of processors 32, 34, 36, 38, each cluster having a respective shared memory. Each of the subsets of data can be sorted by a respective cluster of processors.

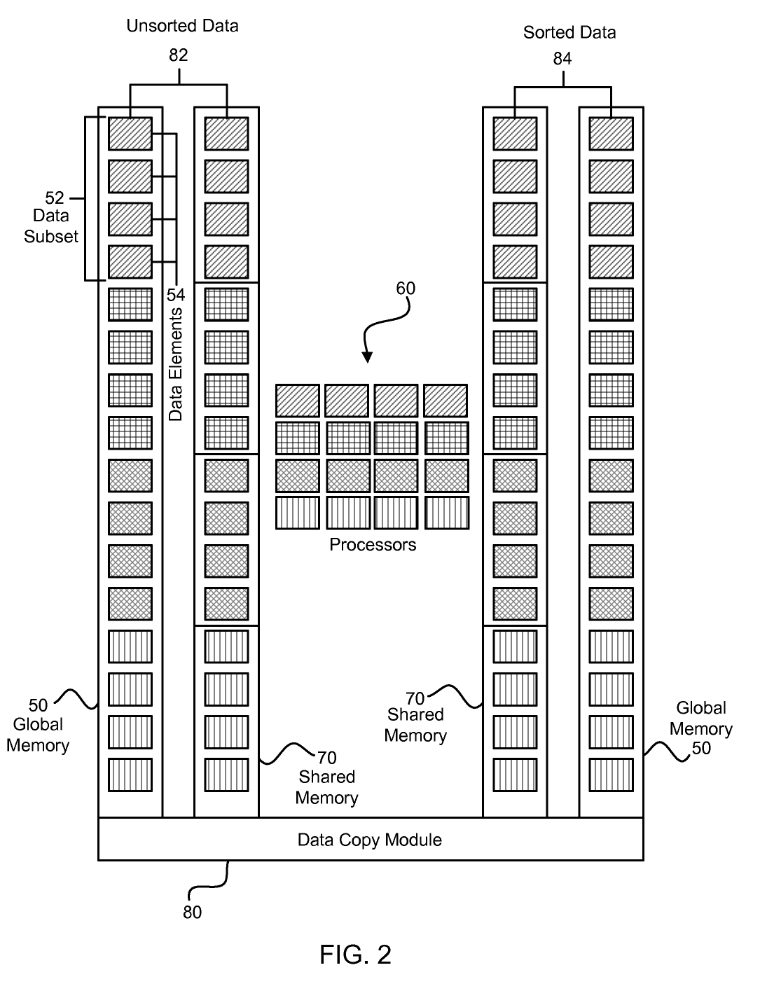

Referring to FIG. 2, a block diagram is shown for a multi-core processing system for data sorting in accordance with an embodiment. A global memory device 50 is provided which may be configured to store data sets for the multi-core processing system. As described above, GPUs may include shared memory which is shared among processors in a cluster but is not necessarily shared between clusters of processors. Such GPU configurations may also include global memory. The global memory may be separate from the shared memory and may be accessed and used by all of the clusters of processors. Global memory often may not be as fast as the shared memory (i.e., read/write speeds may be slower).

An unsorted data set 52 may be stored in the global memory 50. The unsorted data set can include a plurality of data elements 54 which are not sorted. The data elements may include any form of data elements known in the art. For example, data elements may include letters, numbers, characters, marks, strings, etc. The unsorted data set may originate outside of the GPU device and be sent to the GPU, at which point the unsorted data can be stored in the global memory.

A plurality of processors 60 may be included in the multi-core processing system. The plurality of processors may include a plurality of clusters of processors. Each cluster of processors may further include shared processor memory 70. The shared processor memory may comprise a shared memory device. The clusters of processors can be configured to sort unsorted data sets in parallel in the shared processor memory. A selected cluster of processors may include at least as many processors as a number of the data elements in an unsorted data set in shared processor memory. As has been described, providing at least as many processors as a number of data elements to be sorted can increase sorting rates and efficiency.

The system may include a data copy module 80. The data copy module can be configured to copy the unsorted data set from the global memory device 50 to the shared processor memory 70 for the selected cluster of processors to sort. The data copy module can also be configured to copy sorted data from the shared memory of the selected cluster of processors to the global memory device. Copying between the global memory and the shared memory or the processor clusters can be done in parallel.

FIG. 2 represents a flow of data in a sorting process and not necessarily a particular device configuration. For example, FIG. 2 includes a global memory device 50 and a shared memory device 70 to the left of the processors 60 and a global memory device 50 and shared memory device 70 to the right of the processors. The global memory device on the left and on the right may be the same device, and the shared memory device on the left and on the right may also be the same device. The diagram depicts a flow of unsorted data 82 on the left to sorted data 84 on the right, showing a progression from unsorted data in global memory to unsorted data in shared memory to sorting to sorted data in shared memory to sorted data in global memory.

Many different methods of sorting data are known in the art. Various suitable sorting devices and methods may be implemented with the systems and methods presented herein. However, some example features of sorting in accordance with an embodiment will be described. In one aspect, each cluster of processors comprises a bitonic sorting network. Sorting an unsorted data set may comprise performing a bitonic sort function. A bitonic sort is where data elements can be compared and swapped (if necessary) in parallel. In this way, data elements may be sorted simultaneously or substantially simultaneously. Each processor in each cluster of processors may be configured to execute substantially the same sorting steps. This can simplify a system and increase overall sorting efficiency. Sorting of one unsorted data set can be performed independently of sorting of another unsorted data set.

In one embodiment, processor clusters may be used to perform intra-job sorting or inter-job sorting. An example of inter-job sorting may be similar to what has been described. Namely, a plurality of sorting jobs are presented and divided among processor clusters for completion. Each processor cluster may receive a different and separate sorting job which may be completely independent of any other sorting jobs. Intra-job sorting may be where a larger sorting job comprises a number of smaller sorting jobs. Different subsets (e.g., the smaller sorting jobs) of the larger sorting job may be divided among different processor clusters for sorting. The subsets may be sorted and then merged. In one example, this operation may be sufficient to complete the larger sorting job. In another example, a further sorting operation may be performed to sort the results of the completed smaller sorting jobs in order to complete the larger sorting job. This further sorting operation may utilize either the shared or the global memory, as may be available depending upon cluster and system configuration.

In one embodiment, a plurality of sorted data sets can be copied in parallel from the shared memory device for each of a plurality of rows of processors to the global memory device after each of the clusters of processors which received an unsorted data set has completed sorting the data set. As an example, a plurality of unsorted data sets may be in global memory. These unsorted data sets may be copied in parallel to shared memory for processor clusters. The processor clusters may have been mapped into a processor grid, as has been described. The unsorted data sets are sorted by the processors using the shared memory. Once all of the unsorted data sets are sorted, the sorted data sets can all be copied in parallel to the global memory from the shared memory. Waiting until all of the sorting jobs have been completed to copy from shared memory to global memory can increase overall system efficiency since only one copy function is being performed.

In one aspect, the system may redistribute a network flow to efficiently sort unsorted data using the multi-core processing system. The flow may be redistributed to many sorting nodes in parallel. The system may be used to solve mathematical model networks, linear systems, linear programming, maximum flow problems, etc.

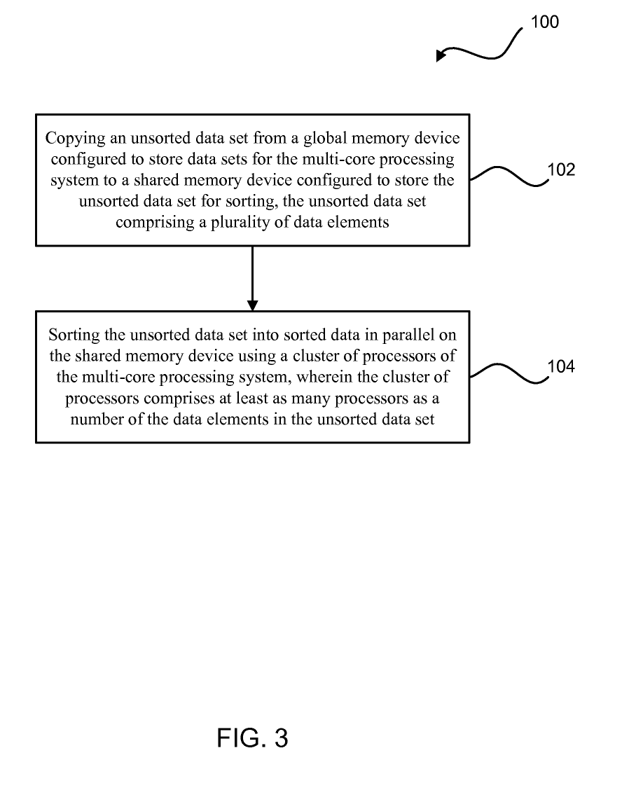

Referring to FIG. 3, a flow diagram depicts a method 100 for sorting data using a multi-core processing system in accordance with an embodiment. An unsorted data set is copied 102 from a global memory device to a shared memory device. The global memory device can be configured to store data sets for the multi-core processing system. The shared memory device can be configured to store unsorted data sets for sorting. The unsorted data sets may comprise a plurality of data elements. The shared memory can also be configured to store sorted data sets after unsorted data sets have been sorted and at least until the sorted data sets are copied to the global memory. The unsorted data set can be sorted 104 into sorted data in parallel on the shared memory device using a cluster of processors of the multi-core processing system, wherein the cluster of processors comprises at least as many processors as a number of the data elements in the unsorted data set. The sorted data can be copied from the shared memory device to the global memory device.

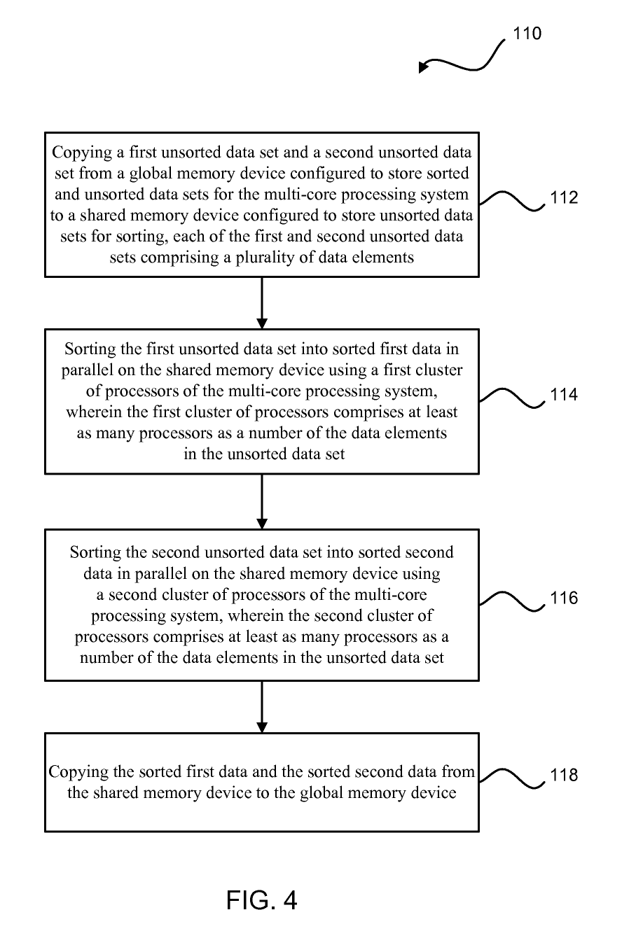

FIG. 4 is a flow diagram of a method 110 for sorting a plurality of unsorted data sets using a multi-core processing system in accordance with an embodiment. A first unsorted data set and a second unsorted data set can be copied 112 from a global memory device configured to store sorted and unsorted data sets for the multi-core processing system to a shared memory device configured to store unsorted data sets for sorting, each of the first and second unsorted data sets comprising a plurality of data elements. The first unsorted data set can be sorted 114 into sorted first data in parallel on the shared memory device using a first cluster of processors of the multi-core processing system, wherein the first cluster of processors comprises at least as many processors as a number of the data elements in the unsorted data set. The second unsorted data set can be sorted 116 into sorted second data in parallel on the shared memory device using a second cluster of processors of the multi-core processing system, wherein the second cluster of processors comprises at least as many processors as a number of the data elements in the unsorted data set. The sorted first data and the sorted second data can be copied 118 from the shared memory device to the global memory device.

Using a processing device, such as GPU, can provide a faster and more efficient way to sort comparatively small data sets in a faster and more efficient manner and can more fully utilize all available hardware resources. Also, the system can scale up to any number of processors. As the number of processors becomes larger, a size of sorting jobs to be performed may likewise be increasable.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A multi-core processing system for data sorting, comprising:
a global memory device configured to store data sets;
a shared memory device configured to store data sets;
a plurality of processors comprising a plurality of clusters of processors, each cluster of processors further comprising shared processor memory, and each cluster of processors being configured to sort an unsorted data set in parallel in the shared processor memory, and wherein a selected cluster of processors comprises at least as many processors as a number of the data elements in the unsorted data set in shared processor memory; and
a data copy module configured to copy an unsorted data set from the global memory device to the shared processor memory for the clusters of processors to sort

2. A system in accordance with claim 1, wherein the data copy module is further configured to copy sorted data from the shared memory of the clusters of processors to the global memory device.

3. A system in accordance with claim 1, wherein the plurality of processors form a graphical processing unit (GPU).

4. A system in accordance with claim 1, wherein the plurality of processors form a central processing unit (CPU).

5. A system in accordance with claim 1, wherein each cluster of processors comprises a bitonic sorting network.

6. A system in accordance with claim 1, wherein each cluster of processors is configured to sort a different unsorted data set in parallel.

7. A system in accordance with claim 6, wherein the data copy module is configured to copy sorted data sets in parallel from each of the clusters of processors to the global memory device.

8. A system in accordance with claim 6, wherein the data copy module is configured to copy unsorted data sets in parallel from the global memory device to one or more of the clusters of processors.

9. A system in accordance with claim 1, wherein a processor in the cluster of processors sorts a data element substantially simultaneously with other processors in the cluster of processors which have data elements to sort.

10. A system in accordance with claim 1, wherein each processor in each cluster of processors is configured to execute same sorting steps.

11. A method for sorting data using a multi-core processing system, comprising:
copying an unsorted data set from a global memory device configured to store data sets for the multi-core processing system to a shared memory device configured to store the unsorted data set for sorting, the unsorted data set comprising a plurality of data elements; and
sorting the unsorted data set into sorted data in parallel on the shared memory device using a cluster of processors of the multi-core processing system, wherein the cluster of processors comprises at least as many processors as a number of the data elements in the unsorted data set.

12. A method in accordance with claim 11, further comprising copying the sorted data from the shared memory device to the global memory device.

13. A method in accordance with claim 11, further comprising mapping processors into the cluster of processors to efficiently maximize use of resources of the multi-core processing system.

14. A method in accordance with claim 13, wherein mapping processors further comprises logically mapping processors into processor clusters.

15. A method in accordance with claim 14, wherein processors in different clusters sort different data sets.

16. A method in accordance with claim 15, further comprising copying a plurality of sorted data sets in parallel from the shared memory device for each of the plurality of clusters of processors to the global memory device after each of the clusters of processors which received an unsorted data set has completed sorting the data set.

17. A method in accordance with claim 1 1, wherein the cluster of processors forms a bitonic sorting network, and wherein sorting the unsorted data set further comprises performing a bitonic sort function.

18. A method for sorting data using a multi-core processing system, comprising:
copying a first unsorted data set and a second unsorted data set from a global memory device configured to store sorted and unsorted data sets for the multi-core processing system to a shared memory device configured to store unsorted data sets for sorting, each of the first and second unsorted data sets comprising a plurality of data elements;
sorting the first unsorted data set into sorted first data in parallel on the shared memory device using a first cluster of processors of the multi-core processing system, wherein the first cluster of processors comprises at least as many processors as a number of the data elements in the unsorted data set;
sorting the second unsorted data set into sorted second data in parallel on the shared memory device using a second cluster of processors of the multi-core processing system, wherein the second cluster of processors comprises at least as many processors as a number of the data elements in the unsorted data set; and
copying the sorted first data and the sorted second data from the shared memory device to the global memory device.

19. A method in accordance with claim 18, wherein sorting the first unsorted data set is independent of sorting the second unsorted data set.

20. A method in accordance with claim 18, further comprising using the first and second sorted data sets to solve a mathematical model network.
